(19) United States
(12) Patent Application Publication
(10) Pub. No.: US 2014/0340918 A1
(43) Pub. Date: Nov. 20, 2014

(54) LASER AND PHOSPHOR BASED LIGHT SOURCE FOR IMPROVED SAFETY

(71) Applicant: Sharp Kabushiki Kaisha, Osaka (JP)

(72) Inventors: James Rowland Suckling, Surrey (GB); David James Montgomery, Oxford (GB); Koji Takahashi, Osaka (JP)

(21) Appl. No.: 14/362,513

(22) PCT Filed: Dec. 21, 2012
(86) PCT No.: PCT/JP2012/008215

§ 371 Date: Jun. 3, 2014

(30) Foreign Application Priority Data
Dec. 22, 2011 (GB) 1122186.8

(51) Int. Cl. F21V 9/16; F21S 8/10; F21V 9/08

(52) U.S. Cl. CPC F21V 9/16; F21V 9/08; F21S 48/1225; F21Y 2101/02
USPC 362/510; 362/84

(57) ABSTRACT

A light source system comprising an optical system which is arranged to project light from a light source into the far-field. The light source comprises a mixture of fluorescent materials which are sensitive to one of two wavebands in either the UV or blue part of the spectrum. The combination of the light emitted from both sets of fluorescent materials combined such that the resulting colour is perceived as white. The light source is illuminated by a plurality of laser emitters comprised of both emitters (35) in the UV waveband and emitters (36) in the blue waveband. The resultant light emitted has an improved eye safety by the reduction of laser light content.

### TECHNICAL FIELD

The present invention relates to a light source for general lighting in which the laser safety of the emitted light must be considered for use in areas where extended exposure of humans to the light is possible.

### BACKGROUND ART

The application of light sources to general lighting is well known. The development of light sources has led to sources with ever increasing luminance, in that there is an increasing output from of light from a decreasing area into a decreasing angular distribution. This has led to development of light sources such as high intensity discharge (HID) lamps based upon noble gases such as Xenon, or light emitting diodes (LED) based upon a semiconductor blue light emitting chip and a phosphor for wavelength conversion from blue to yellow light and the combination of the two wavebands to form white light. Both of these light sources are well known and will not be described further.

Laser based light sources have been developed that offer a further advantage in terms of luminance. The emission from a laser light source is highly restricted in terms of angular distribution and spatial extent, leading to a very high luminance light source. Although the emission from a laser is almost monochromatic, the application of a phosphor can allow conversion of the laser light to wavebands of longer wavelength and broader spectrum. This may lead to a white light source with a broad spectrum from a much more restricted area compared to that of an LED or other light sources.

The following background art describes the use of lasers and phosphors in white light sources:

US 2008/0116473 A1 (Nichia, published 22 May 2008); an illustration of this patent is shown in FIG. 1. This patent proposes a light source 11 made from a light emitting semiconductor element 12 which emits light towards a transparent member 13 which is positioned in a penetrating opening 14 which has sloped sides. The transparent member 13 can be composed of a wavelength conversion material such as phosphor. The transparent member 13 absorbs some of the light emitted from the light emitting semiconductor element 12 and re-emits it at longer wavelength. It is proposed that the light source 11 can comprise a laser diode which emits ultraviolet light and a mix of red, green and blue phosphors that when mixed forms white light. It is also proposed that the light emitting semiconductor element 11 can also be a laser diode which can emit blue light, a portion of which is absorbed by the transparent member 13 which re-emits yellow light, the combination of blue laser light and yellow phosphor light resulting in white light. A similar device is also proposed in U.S. Pat. No. 7,943,945 B2 (CREE, published as US 2006/0049416 on 9 Mar. 2006) whereby the laser diode is replaced by at least one LED which can emit light within the range of blue to UV and a phosphor to down convert the light to provide white light.

US 2011/0175520 A1 (Renaissance Lighting Inc., published 21 Jul. 2011); this patent proposes the use of at least one solid state light source which emits light in a first waveband of 460 nm or less, at least three phosphors which absorb light from the at least one solid state light source and re-emit light of different wavebands, the resultant colour of emission being white. The phosphors are located remotely from the at least one solid state light source. A similar device is also proposed in U.S. Pat. No. 7,902,560 B2 (Philips, 19 Jun. 2008) whereby wavelength converting elements are illuminated by a plurality of light emitting diode chips producing the same general colour and a variation in wavelength of up to 50 nm. The resultant emission from the system is white and the colour temperature can be controlled by changing the relative output power from the chips.

US 2005/0057145 A1 (Nanya Plastics, published 17 Mar. 2005); this patent proposes the use of a semiconductor emitter being either an LED or laser diode emitting in the ultraviolet (UV) or visible purple region defined as 360 nm to 420 nm. The light from the semiconductor device excites a phosphor, causing emission of blue light. This blue light in turn excites other phosphors which emit in either red, green or yellow wavebands. The ratios of the phosphors may be mixed to form white light of varying colour temperature.

US 2011/0157865 A1 (Sharp, published 30 Jun. 2011); an illustration of this is shown in FIG. 2. This patent discloses improved safety for a vehicle headlight 21 light source in which light of a first waveband, disclosed as 405 nm, is emitted from a laser irradiation device 22 and directed onto a fluorescent substance 23 which converts the first waveband to blue-green and red light, resulting in white light. A scattering medium 24 and wavelength selective filter 25 are provided to improve the safety of the device by reducing the directionality, coherence and intensity of the 405 nm laser light which is not converted 26 by the fluorescent substance 23. The filter 25 can be mounted on a cover plate 27. By this arrangement a passive safety device is described for use with a 405 nm laser based white light source.

US 2009/0224652 proposes a white LED that comprises a “multi-chip excitation source” and a phosphor mixture, for example a two-chip source having a UV-emitting LED and a blue-emitting LED with a phosphor mixture that contains a green phosphor and an orange phosphor. In operation, part of the white light output is constituted by photoluminescence by the phosphors and part is constituted by the LED output radiation.

JP 2006 344645 proposes a white light emitting device having two light emitting layers for emitting UV and blue light respectively. The device further includes two fluorescent powders, which are able to absorb light from both light emitting layers and which emit light of different wavelengths to one another.

US 2006/0152140 proposes a light emitting device having two LED sources that emit light with differing spectral outputs from one another and that illuminate a phosphor material including one or more phosphors. The device is intended to provide a higher conversion efficiency colour rendering than prior devices.

US 2006/0197098 proposes a light emitting device having two LEDs that emit light in the blue and green wavelength ranges. They illuminate a phosphor that contains a yellow fluorescent member. It addresses the problem that conventional devices in which a single colour LED is used to eliminate a plurality of fluorescent materials has a low emission efficiency.

US 2004/0256626 addresses the problem that a light source formed of red, green and blue LEDs does not “reproduce a true colourless light”. It proposes the use of LEDs of two different colours that illuminate a phosphor to provide an output that most closely approaches that of “true natural white light”. In one example, green and blue LEDs illuminate a red phosphorescent glue.

### CITATION LIST

### Patent Literature

PTL 1: US 2008/0116473 (Nichia, 22 May 2008)

PTL 2: U.S. Pat. No. 7,943,945 (CREE, 9 Mar. 2006)

PTL 3: US 2011/0175520 (Renaissance Lighting Inc, 21 Jul. 2011)

PTL 4: U.S. Pat. No. 7,902,560 (Philips, 19 Jun. 2008)

PTL 5: US 2005/0057145 (Nanya Plastics, 17 Mar. 2005)

PTL 6: US 2011/0157865 (Sharp Kabushiki Kaisha, 30 Jun. 2011

PTL 7: US 2009/0224652 (Li et al., 10 Sep. 2009)

PTL 8: JP 2006 344645 (Super Nova Electronics Corp, 21 Dec. 2006)

PTL 9: US 2006/0152140 (Brandes et al., 16 Jul. 2006)

PTL 10: US 2006/0197098 (Aihara, 7 Sep. 2006)

PTL 11: US 2004/0256626 (Wang et al., 23 Dec. 2004)

### SUMMARY OF INVENTION

### Technical Problem

The example conventional art as outlined above addresses the provision of white light sources by excitation of fluorescent materials, such as phosphors, by light from semi-conductor devices, such as LEDs or laser diodes, such that white light is emitted. The conventional art describes the use of UV, or purple, laser diodes to excite phosphors in various configurations or blue laser diodes to illuminate phosphors of various configurations, but both systems have complementary problems associated with their employment. A white light source based upon a UV, or purple, laser diode is limited in efficiency due to the conversion of light from UV to white. There is a large Stokes shift from UV wavelengths to those associated with white light, being approximately within the range 430 nm to 750 nm. This Stokes shift results in a loss of energy to heat within the fluorescent material, which is in addition to losses incurred by the fundamental quantum efficiency of such fluorescent materials. Both these factors limit the maximum efficiency of such a white light source. The safety of such devices is, on the other hand, good. The UV, or purple, light emitted from the laser diode contributes only a small part of the brightness of the white light as perceived by a human eye. Therefore, the laser light can be filtered out from any emitted beam, greatly reducing the possible human exposure to laser light that may be incurred and thus improving eye related safety.

By contrast, a laser based white light source which utilises a blue laser diode has a greater efficiency, due to both the reduced Stokes shift from blue wavelengths to white light and the quantum efficiency of the phosphors associated with conversion of blue light to longer wavelengths is generally higher than for phosphors associated with the conversion of UV, or purple, light to longer wavelengths. Furthermore, the blue laser light itself is used to form part of the white light spectrum, reducing the requirement to convert all laser light to white light through the phosphors, thereby further enhancing total efficiency. However, in terms of safety, as the provision of white light requires that some of the blue laser light is emitted from the light source, some exposure of humans to the laser light is inevitable. This will limit the maximum total output that may be achieved by such a light source to be less than the equivalent UV, or purple, laser based white light source.

In summary, a UV, or purple, laser based white light source is less efficient, but safer, than the equivalent blue laser based white light source.

### Solution to Problem

A first aspect of the present invention provides a light source system comprising: at least one first light source for emitting light of a first waveband; at least one second light source for emitting light of a second waveband different from the first waveband; a photoluminescent region including a first photoluminescent material and a second photoluminescent material, the first photoluminescent material for, when illuminated by light of the first waveband, absorbing at least some of the light of the first waveband and emitting light in one or more wavebands of longer wavelength than the first waveband, and the second photoluminescent material for, when illuminated by light of the second waveband, absorbing at least some of the light of the second waveband and emitting light in one or more wavebands of longer wavelength than the second waveband; and an optical system for directing light emitted by the light source system into the far-field; wherein, in use, light emitted from the first photoluminescent material, light emitted from the second photoluminescent material, and light of the second waveband that is not absorbed by the second photoluminescent material combine to give a light output having a desired spectral characteristic; and wherein the or each first light source and the or each second light source are each a semiconductor laser.

### Advantageous Effects of Invention

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1: example of laser based light source, constituting a conventional art.

FIG. 2:l example of a laser based light source in which a filter is included for safety, constituting a conventional art.

FIG. 3a: overview of the main embodiment of the present invention.

FIG. 3b: illustration of the mechanism of operation of the light source and optical system illustrated with enclosure.

FIG. 3c: plan view of the light source. Alternative spatial distribution of the two light source constituent materials in a tiled array.

FIG. 3d: plan view of the light source. Alternative spatial distribution of the two light source constituent materials in a non-tiled array.

FIG. 3e: plan view of the light source. Alternative spatial distribution of the two light source constituent materials in a non-regular array.

FIG. 4a: further embodiment of the present invention. Spatial separation of the light source constituent materials.

FIG. 4b: plan view of the light source. Details of boundary region between different constituent materials.

FIG. 5: further embodiment of the present invention. Formation of a two tier substrate for the light source.

FIG. 6: further embodiment of the present invention. Alternative composition of the light source constituent materials.

FIG. 7: further embodiment of the present invention. Example of an optical system including reflector and lens parts.

FIG. 8: further embodiment of the present invention. Example of an optical system comprising only a reflector.

FIG. 9: further embodiment of the present invention. Rotation of the light source with respect to the optical axis of the optical system.

FIG. 10: incorporation of the optical system into a headlight.

FIG. 11: system overview of the present invention.

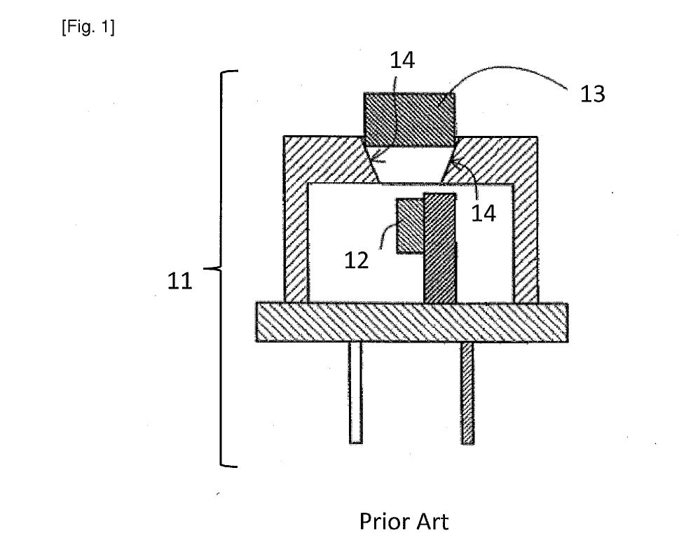

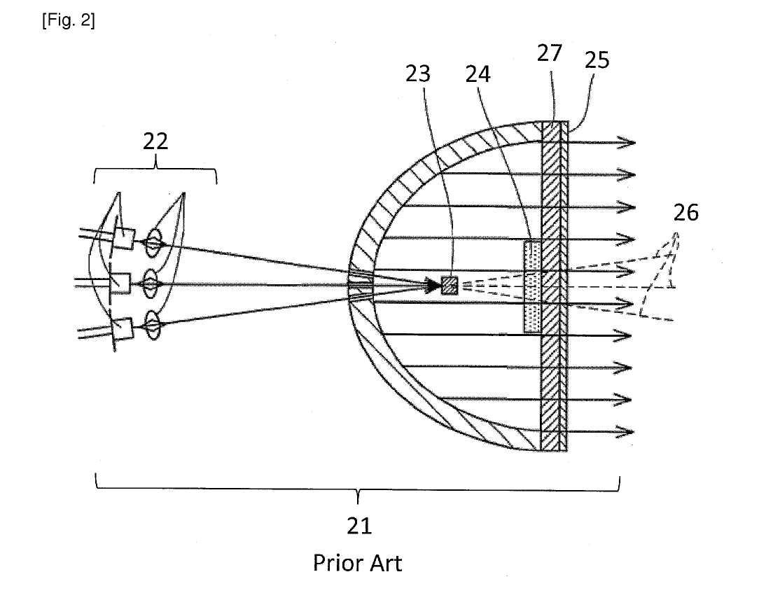

### DESCRIPTION OF EMBODIMENTS

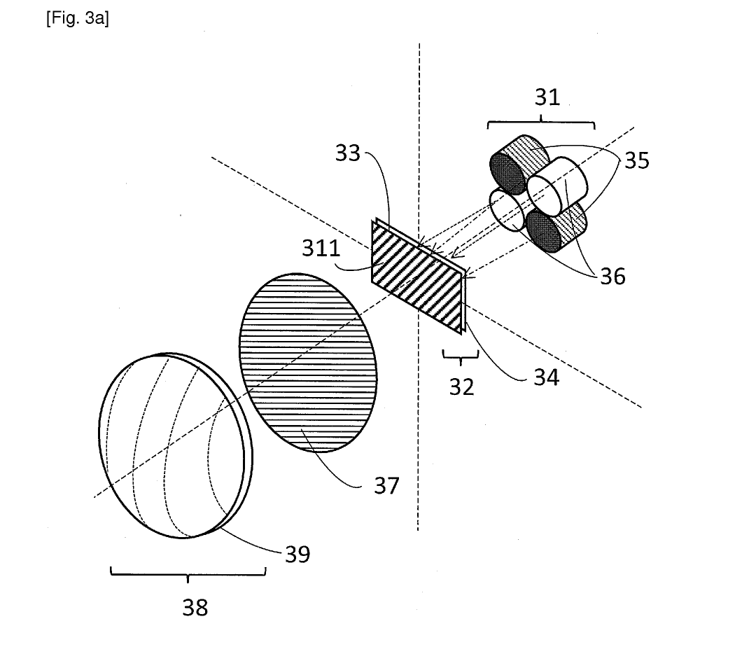

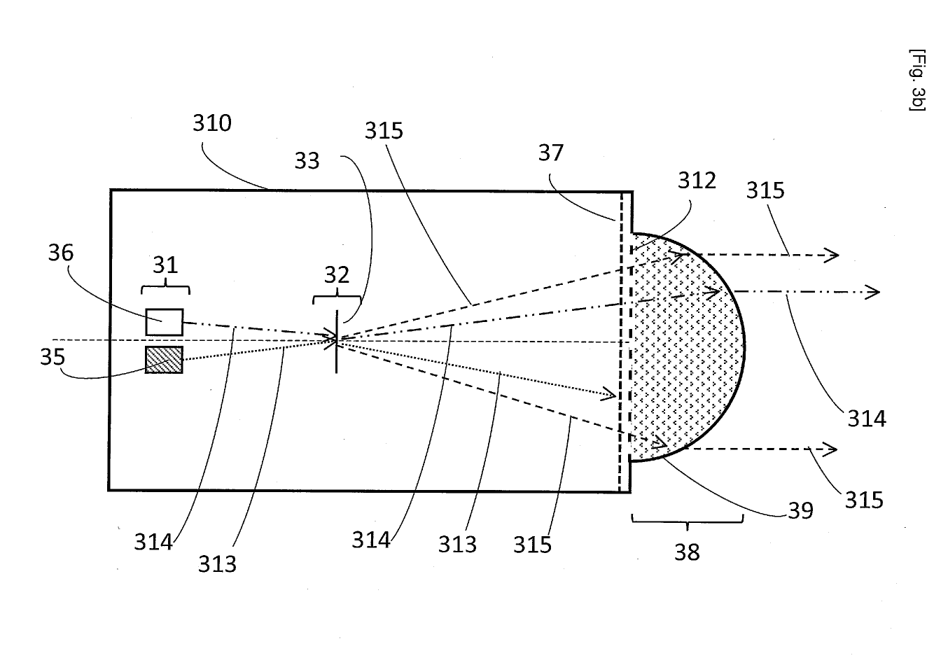

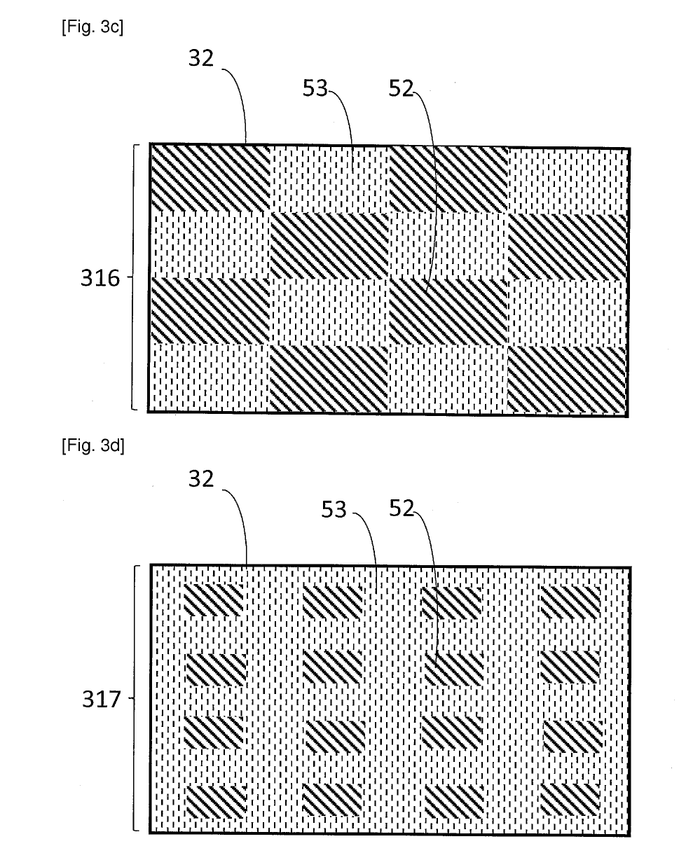

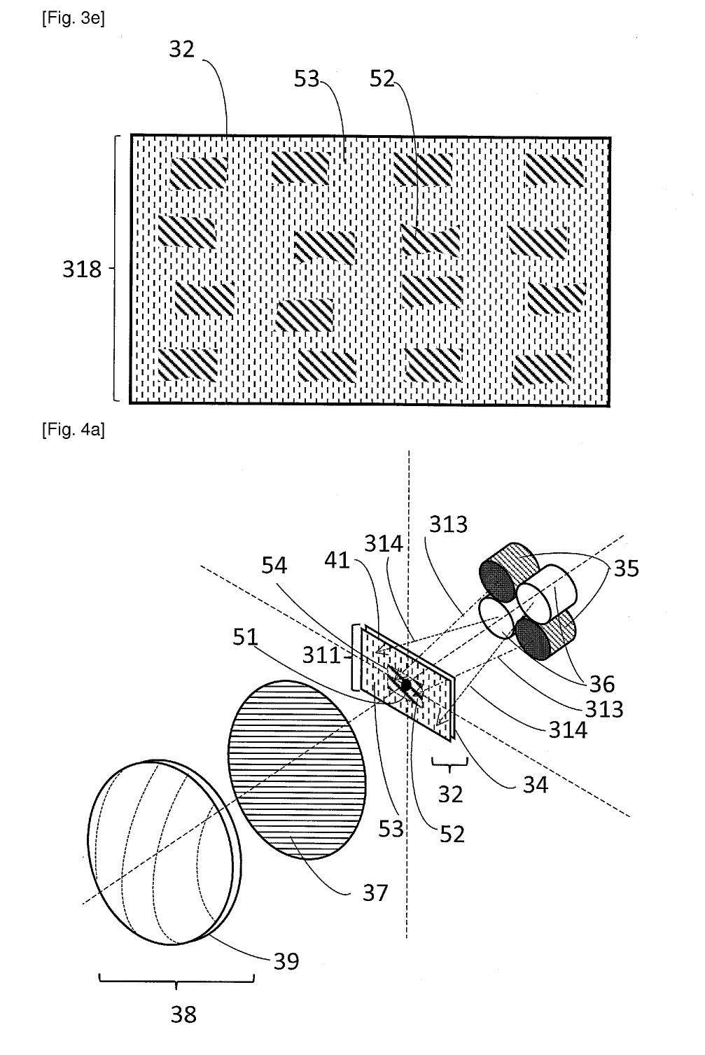

A preferred embodiment of the present invention is described herein and an overview of the same is presented in FIGS. 3a and 3b. An array of laser emitters 31 is arranged to illuminate a light source 32 which is comprised by a mixture of fluorescent materials 33 which are deposited evenly over the entire face area 311 of a substrate 34. The substrate 34 may comprise either an optically transparent material, such as, but not limited to, clear glass, sapphire or plastic or a reflective material such as, but not limited to, metals such as aluminium or silver. The choice of material is dependent on application chosen at the time of design. The array of laser emitters 31 is comprised of a mixture of laser emitters of light in the UV waveband 35, herein termed “UV laser emitters” 35, and laser emitters of light in the blue waveband 36, herein termed “blue laser emitters” 36. The UV waveband is considered to be in the wavelength range of 360 nm to 425 nm (as noted above, the term “UV” is used herein is intended to include wavebands that extend into, or that are in, the purple region of the spectrum as well as wavebands solely in the UV region of the spectrum), and the blue waveband is considered to be within the wavelength range 425 nm to 470 nm. The array of laser emitters 31 is considered to consist of at least one of each of the UV laser emitters 35 and blue laser emitters 36, but should not be limited to only one of each, nor limited to equal numbers of each. The fluorescent material 33 is comprised of a mixture of two sub-mixtures of phosphors in which one sub-mixture is comprised of two or more phosphors which are UV absorbing phosphors and the other sub-mixture is comprised of one or more phosphors which are blue absorbing phosphors. The UV absorbing phosphor mixture may comprise two or more phosphors which, when illuminated by light in the UV waveband, emit light in wavebands comprising one or more of red, green, blue, orange or yellow. Similarly, the blue absorbing phosphor mixture may comprise one or more phosphors which, when illuminated by light of the blue waveband, emit light in waveband comprising one or more of red, green, orange or yellow. (It should be understood that a reference to a phosphor that emits light of a particular wavelength or wavelength range is not limited to a single phosphor that emits light of that particular wavelength or wavelength range, but is also intended to cover a mixture of two or more phosphors that emit light of that wavelength or wavelength range. Thus, the term “phosphor that emits red light”, for example, covers a mixture of two or more different phosphors that emit red light as well as a single phosphor that emits red light.) The colour balance of all of the combined wavebands from the phosphor, and inclusive of that part of the light in the blue waveband emitted by the blue laser emitters that is not absorbed by the second sub-mixture of the one or more blue absorbing phosphors, is perceived as white, for example may fall inside a shape superimposed upon the CIE 1931 standard colorimetric observer chart defined by the coordinates (x, y) as follows: (0.310, 0.348), (0.453, 0.440), (0.500, 0.440), (0.500, 0.382), (0.443, 0.382), (0.310, 0.283).

The combination of wavebands perceived as white is emitted from the light source 32 and passes through a wavelength selective filter 37. The wavelength selective filter 37 is designed to remove light from the UV waveband only. This is defined as light with a wavelength less than 425 nm. The wavelength selective filter 37 is highly transmitting to wavelengths longer than 425 nm. This provides a passive safety mechanism for the control of emission of laser light in the UV waveband.

An optical system 38 is provided to project the light from the light source 32 into the far field. The optical system 38 is depicted as a primary lens 39 in this illustration, however, it should not be limited to such and can comprise, but not be limited to, optical elements such as reflectors, lenses, minors or diffraction optics.

The location of the light source 32 may be in the proximity of a focal point of the optical system 38. This will allow good quality projection of the light from the light source 32 into the far-field. However, it is not required for this present invention that the light source 32 is located exactly at a focal point, and the light source 32 may be removed by some distance from a focal point. In FIG. 3b and other figures the light source 32 is depicted as being located at a focal point, this is for clarity in the diagrams—whilst locating the light source 32 in the proximity of a focal point of the optical system 38 is preferred, it is not a necessary requirement.

The entire system as depicted in FIG. 3a should be enclosed such that light emitted from the array of laser emitters 31 cannot exit the enclosure via a route other than through the exit aperture of the system. An example configuration is shown in FIG. 3b, whereby the array of laser emitters 31, comprising both UV laser emitters 35 and blue laser emitters 36, the light source 32 and the wavelength selective filter 37 are completely enclosed by an opaque enclosure 310 such that the only route for light to escape the enclosure 310 is through the optical system 38 and the exit aperture 312. Again the optical system 38 is depicted by a primary lens 39. Light of the UV waveband 313 and blue waveband 314 is emitted towards the light source. Multiple waveband emission from the phosphor 315 is emitted from the light source 32 along with residual laser light of both the UV waveband 313 and blue waveband 314. The multiple waveband emission from the phosphor 315 and light of the blue waveband 314 is permitted to exit the enclosure 310 via the exit aperture 312, whereas the light of the UV waveband 313 is blocked by the wavelength selective filter 37.

The mixture of phosphors within the fluorescent material 33 of the light source 32 may be adjusted to optimise the balance of emission of laser light of the blue waveband 314, such that predefined safety limits are not exceeded. The exact threshold of the safety limit will depend on the intended usage of the light source, but may be those as laid out by the IEC 60825-1 Edition 2 (or later) “Safety of laser products—Part 1: Equipment classification and requirements”, or other mandatory safety documentation. The ratio of mixture of UV absorbing phosphors and blue absorbing phosphors may be adjusted to optimise the efficiency and safety of the light source simultaneously. It is this freedom of adjustment wherein lies the advantage of the present invention.

The provision of white light from the light source as described is the result of a combination of light emitted from UV absorbing phosphors and blue absorbing phosphors. As some of the UV absorbing phosphors will emit light in the blue waveband it is inevitable that this light will cause some excitation of blue absorbing phosphors. Therefore, it is necessary to balance the ratios of the mixture of phosphors to account for this possible interaction between the two mixtures of phosphors. However, it is not intended that this be the primary route to generating light from blue absorbing phosphors, where possible this should only be achieved via excitation of light output from the blue laser emitters.

FIG. 3c illustrates an alternative arrangement of the UV absorbing phosphors 52 and blue absorbing phosphors 53. The light source 32 is shown in plan view. Instead of a uniform mixture of the two sets of phosphors as shown in previous figures, the two sets of phosphors are distributed in a tiled array 316. This arrangement may allow for a simplified light source construction as the correct ratio of mix of phosphors does not need to be maintained over the entire light source 32. The array is shown as being a four by four matrix for clarity, but the number of columns and rows can be greater or smaller and should not be limited to the arrangement shown. Similarly the array is shown as being rectilinear, but other shapes that can be tiled may also be considered, for example, triangles or hexagons.

FIG. 3d illustrates another example configuration of the UV absorbing phosphors 52 and blue absorbing phosphors 53. The lights source 32 is shown in plan view. Instead of a uniform mixture of the two sets of phosphors as shown in previous figures, the two sets of phosphors are distributed in a non-tiled array 317. In the example shown, spots of the UV absorbing phosphors 52 are set within a background of the blue absorbing phosphors 53. As in the description of FIG. 3c, the exact shape of the spots may not need to be the shape shown and can take other shapes. However, in this example, the shapes need not be limited to those that can be tiled, and may be, by way of example, circular. The filling fraction of the spots compared to the background may be varied according to the desired ratio of phosphors within the light source. Furthermore, the spots may constitute the blue absorbing phosphors within a background of UV absorbing phosphors, i.e. the inverse of that shown in FIG. 3d.

FIG. 3e shows another illustration of a possible arrangement of phosphors whereby the spots of UV absorbing phosphor 52 are within a background of blue absorbing phosphors 53. The light source 32 is shown in plan view. The spots 52 are shown as being an irregular shape and in a non-regular array 318, i.e. the location of each spot is displaced from the position of a regular array by a non-specified distance and direction. As in the previous examples, the spot size and shape may differ from that shown and the composition of the spots and background may be inverted.

In the preceding embodiments it is not required that the UV absorbing phosphors 52 and the blue absorbing phosphors 53 are illuminated at an equal intensity by the UV laser emitters 35 or the blue laser emitters 36 respectively. Indeed the UV laser emitters 35 may be controllable independently from the blue laser emitters 36 so that the intensity of the illumination may be reduced or increased relatively, thereby changing the ratio of the contribution to the output light by either of the UV absorbing phosphors 52 or the blue absorbing phosphors 53. This may be to the degree that the light emitted is comprised solely by that of the UV absorbing phosphors 52 or solely by that of the blue absorbing phosphors 53 (and the unabsorbed light from the blue laser emitters), if so desired.

FIG. 4a illustrates a further embodiment of the present invention whereby the light source 32 is formed from a fluorescent material whose constitution varies as a function of position relative to the focal point 51 of the optical system 38. The fluorescent material closest to the focal point 51 is formed from a mixture of UV absorbing phosphors 52. The fluorescent material furthest away from the focal point 51 is formed from a mixture of blue absorbing phosphors 53. The particular mixtures of the different types of phosphor are the same as outlined in the main embodiment, such that the mixture of UV absorbing phosphors 52 closest to the focal point 51 absorbs light of the UV waveband and emits light of multiple wavebands, of longer wavelengths, which combine to form a colour perceived as white, the light of the UV waveband then being removed by a wavelength selective filter 37, and the mixture of blue absorbing phosphors 53 further from the focal point 51 absorbs light of the blue waveband and emits light of multiple wavebands, of longer wavelengths, which combine with a portion of the original laser light of the blue waveband to form a colour perceived as white. (In this embodiment a viewer may see light that is either predominantly from the UV absorbing phosphors 52 or predominantly from the blue absorbing phosphors 53, depending on their position. It is therefore advantageous if the light from the UV absorbing phosphors 52 has a similar spectral characteristic to light from the blue absorbing phosphors 53 so that the viewer perceives a spectral characteristic that does not vary significantly with their location. The major difference in this embodiment to previous embodiments is caused by variation in the mixtures of phosphor as a function of position relative to the focal point 51 of the optical system 38.

The light emitted from the mixtures of UV absorbing phosphors 52 is most strongly collimated by the optical system 38, due to the proximity to the focal point 51. The light emitted from the mixture of blue absorbing phosphors 53 is more divergent in angle due to the greater distance from the focal point 51. According to laser safety regulations (e.g. IEC 60825-1), a light source with a constant power and spatial extent poses a lower risk to the eye if the emitted light is more divergent in angle than the same light source with a narrower angular distribution. Therefore, by causing the laser light of the blue waveband to be emitted over a wider angular distribution, the eye safety of the system is enhanced. The reason for the variation in divergence of light as a function of position from the focal point 51 of the optical system 38 is the difference in etendue of the two mixtures of phosphors. Etendue is well known to someone skilled in the art and will not be described herein, but in summary, the angular distribution of the light emitted from all points of the light source 32 is the same, due to the physical process of emission of light from a phosphor being constant across the different wavebands present, but the area over which the different mixtures of phosphor emit light is different. The light perceived as white generated from the UV absorbing phosphors 52 is emitted from a smaller area, therefore it is more readily collimated by an optical system 38 of a given size. The light perceived as white which is emitted from the blue absorbing phosphors 53 is emitted from a larger area. Therefore, the same optical system 38 is less capable of collimating the light, resulting in a more angularly divergent projected beam.

To facilitate the system characteristics outlined above, laser light of the UV waveband 313 emitted from the UV laser emitters 35 is directed to the mixture of UV absorbing phosphors 52 located close to the optical system 38 focal point 51 and laser light of the blue waveband 314 emitted from the blue laser emitters 36 is directed to the mixture of blue absorbing phosphors 53 located further from the optical system 38 focal point 51.

The arrangement described in the above embodiment offers advantage in applications of lighting such as automotive front lighting, whereby the headlight of the automobile must provide strong illumination into a narrow cone with a small angular range for good visibility at a long distance when driving in the dark, but also provide a wide illumination pattern to sufficiently illuminate the sides of the road.

In principle, it would be possible for the UV laser emitters 35 to be controllable independently of the blue laser emitters 36. It is not a requirement of the present invention that the different regions of UV absorbing phosphor 52 or blue absorbing phosphor 53 are illuminated constantly, or at equal intensity by the UV or blue laser emitters 35, 36. To that end the emission from the different phosphors may be varied in intensity relative to the other. It is allowed that one or other of the phosphors may have an illumination that is reduced or increased compared to the other. Indeed, the illumination of one or other of the phosphors may be reduced to zero, causing no emission from that region. Moreover, this embodiment may provide, for example, a lighting system that can operate in either a narrow angle mode (if only the UV laser emitters 35 are illuminated) or a wide angle mode (if the UV laser emitters 35 and the blue laser emitters 36 are illuminated).

For clarity the distribution of the different mixtures of phosphors is shown in FIG. 4a as having a hard and thin boundary 54 between the different mixtures. In a real system it would not be possible to have such a perfectly thin boundary if the different mixtures of UV absorbing phosphor 52 and blue absorbing phosphors 53 were deposited on one substrate 34. Some mixing between the different kinds of phosphors would occur in the boundary region 55, as shown in FIG. 4b. Indeed, under some circumstances an extended boundary region 55 may be beneficial. An extended boundary region 55 would enhance tolerance of the system to slight variations in the colour temperature of the light perceived as white which is emitted from the different mixtures of phosphors, by causing a more gentle transition from one colour temperature to the other in the far-field beam spot generated by the optical system 38 as a function of position within the beam spot.

The light source 32 and subsequent shapes of the different mixtures of the phosphors is shown as being rectilinear polygons. The shape of the light source 32 and shapes of the areas of different mixtures of phosphors upon the light source 32 should not be limited to such a shape and may be other shapes including, but not be limited to, circular, oval, square, triangular, pentagonal and shapes with a higher number of sides, bow tie, hour glass or other irregular shapes. Equally the shapes of the different regions of the fluorescent materials may be such that the UV absorbing phosphor 52, blue absorbing phosphor 53 and the boundary region 55 each have different shapes which may include, but not be limited to, those outlined above.

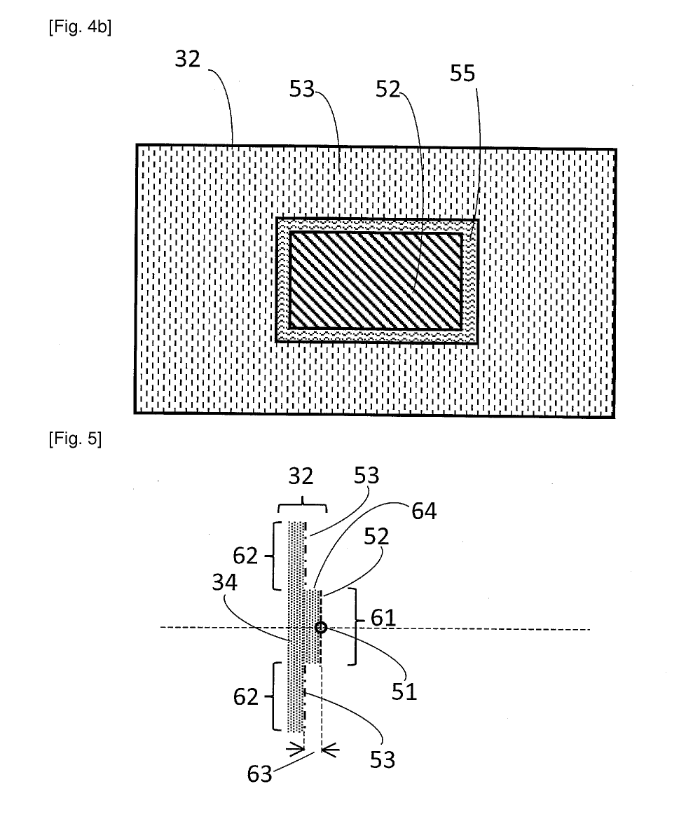

FIG. 5 shows a further embodiment of the present invention whereby the UV absorbing phosphors 52 are deposited on a raised central section 61 of the substrate 34 relative to the blue absorbing phosphors 53. The shape of the light source 32 as viewed in plan view may be any of the same as outlined in the previous embodiment, therefore, only the cross-section of the light source 32 is shown in FIG. 5 to highlight the raised central section 61. By this arrangement the surface of the raised central section 61 is located coincident to the focal point 51 of the optical system. The optical system is not shown in FIG. 5 to allow the source to be represented at a size large enough to aid clarity of description. The surface of the outer section 62, which is also the location of the blue absorbing phosphors 53, is set back from the focal point 51 of the optical system by some distance 63. As in previous embodiments the substrate 34 may be made from a transparent or reflecting material. This arrangement in this embodiment allow for a more simple construction of the light source 32, whereby the boundary region between the phosphors absorbing to light of the UV waveband and phosphors absorbing to light of the blue waveband may be sharpened by presence of the discontinuity 64 in the substrate 34.

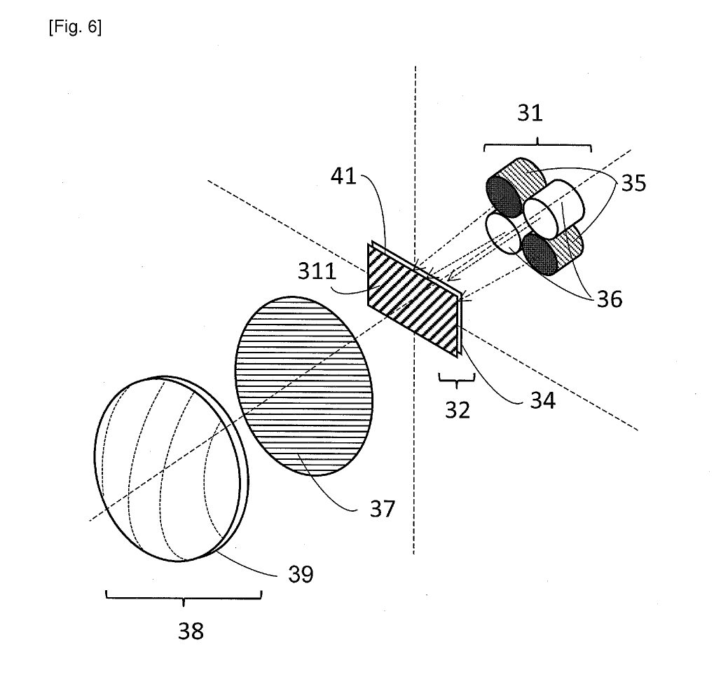

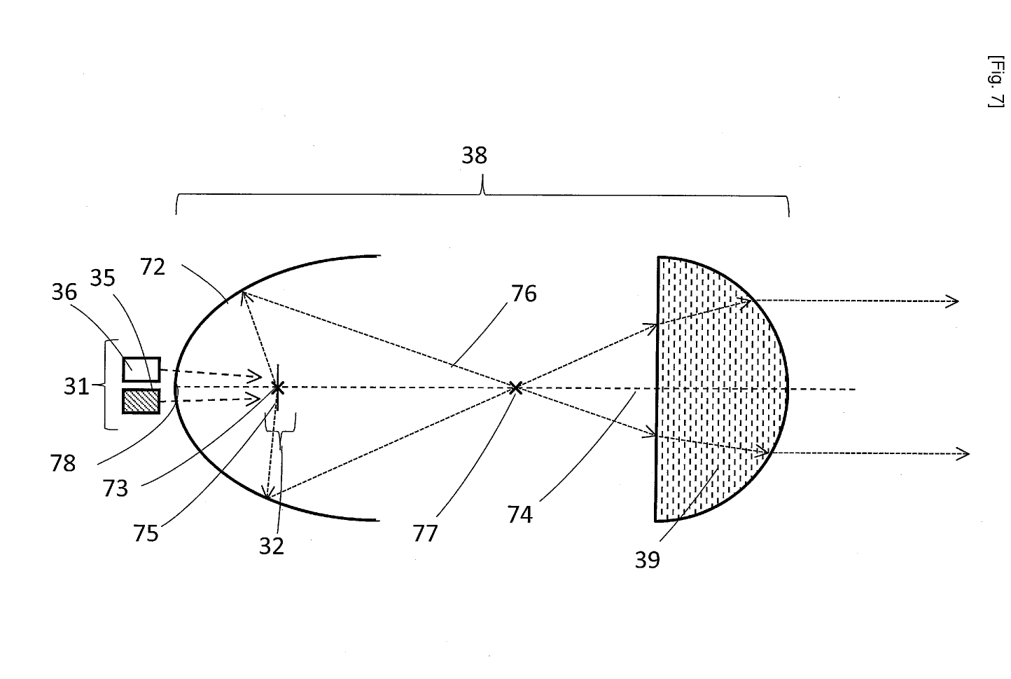

FIG. 6 illustrates a further embodiment of the present invention whereby the ratio of the mixture of phosphors is different to the first embodiment. For this reason the fluorescent material 41 on deposited on the substrate 34 in the light source 32 in FIG. 6 is denoted by a different numeral (41). The fluorescent material 41 is made from a mixture of phosphors in which the UV absorbing phosphor is formed solely from a phosphor (or phosphor mixture) which emits light in the blue waveband. The mixture of blue absorbing phosphors is created as in the main embodiment. The resultant mixture of both types of phosphor emits wavebands of different colours that when combined form a colour perceived as white. However, in this embodiment the vast majority of the light in the blue waveband forming the light perceived as white is formed from the emission from the UV absorbing phosphor which emits in the blue waveband, not the emission from the blue laser emitters which emit light in the blue waveband 36. As before, the UV laser light from the emitters 35 and of the UV waveband is removed by the wavelength selective filter 37, prior to exiting the system through the optical system 38. The arrangement of the two sub-mixtures of UV absorbing phosphors and blue absorbing phosphors may be as described in any of the previous embodiments relating to FIGS. 3c, 3d and 3e, but not FIG. 4a or 4b.

By this method the proportion of the light perceived as white which is constituted of laser light in the blue waveband in greatly reduced, thereby enhancing the safety of the light source 32 with regard to laser safety regulations (e.g. IEC 60825-1) and the efficiency of the light source 32 is still improved over that of a UV laser emitter based system alone.

FIG. 7 illustrates a further embodiment of the present invention whereby the optical system 38 is formed from an elliptical reflector 72 and a primary lens 39. The light source 32 is located at the first focal point 73 of the elliptical reflector 72 and orientated such that the optical axis 74 of the optical system 38 is normal to the surface 75 of the light source 32. The primary lens 39 projects the light 76 from the light source 32 passing through the second focal point 77 of the elliptical reflector 72 into the far-field. The focal point of the primary lens 39 is preferably co-incident or substantially co-incident with the second focal point 77 of the elliptical reflector 72. The light source 32 is illuminated by an array of laser emitters 31 comprising a mixture of UV laser emitters 35 and blue laser emitters 36.

FIG. 7 illustrates an optical system 38 based upon an elliptical reflector 72, but is it possible to use reflectors with others conic forms including spherical, parabolic and hyperbolic. It is also possible to use other aspheric reflector geometries, based upon those disclosed above, whereby the basic form of the conic section is perturbed by higher order contributions. This is demonstrated in Equation 1:

$$\begin{matrix}[ Math . 1 ] & \\ z = \frac{{cr}^{2}}{1 + \sqrt{1 - ( 1 + k ) {c}^{2} {r}^{2}}} + \sum {a}_{i} {r}^{2 i} & Equation 1\end{matrix}$$

Where c is the base curvature of the surface at the reflector vertex 78, r is the radial coordinate measured perpendicularly from the optical axis 74, k is the conic constant and aⁱr²ⁱ are the higher order aspheric terms.

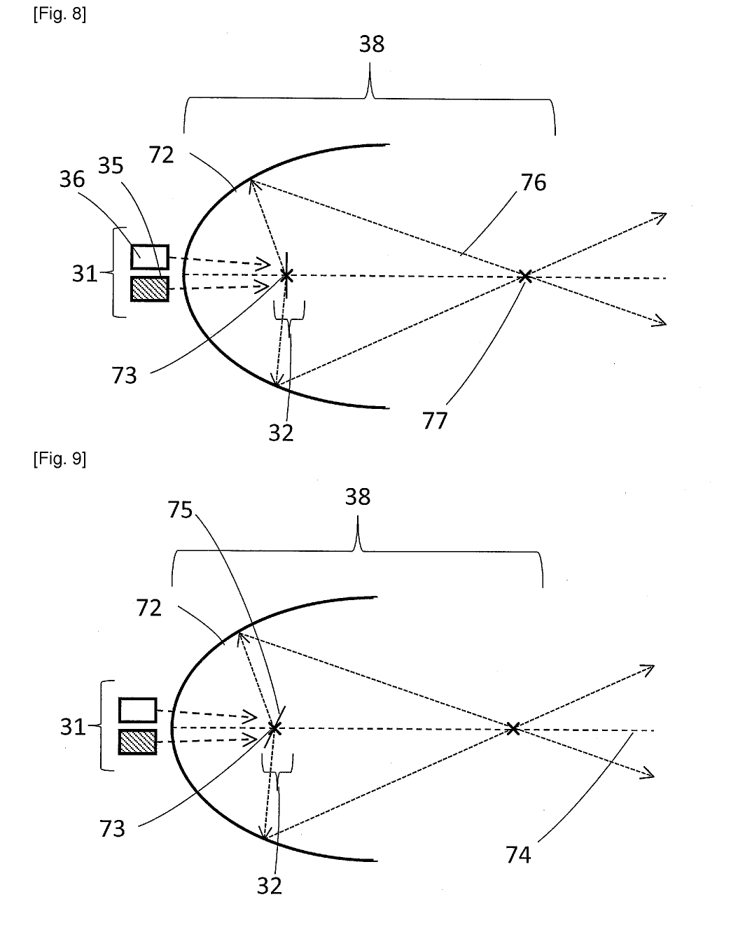

FIG. 8 illustrates another optical system 38 which is based solely upon an elliptical reflector 72, which is identified by the presence of both a first focal point 73 and a second focal point 77. As in the previous embodiment, the elliptical reflector 72 may be formed from other conic sections and also conic sections perturbed by aspheric terms as outlined in Equation 1. The light source 32, array of laser emitters 31, UV laser emitters 35 and blue laser emitters 36 and emitted light 76 are shown for reference.

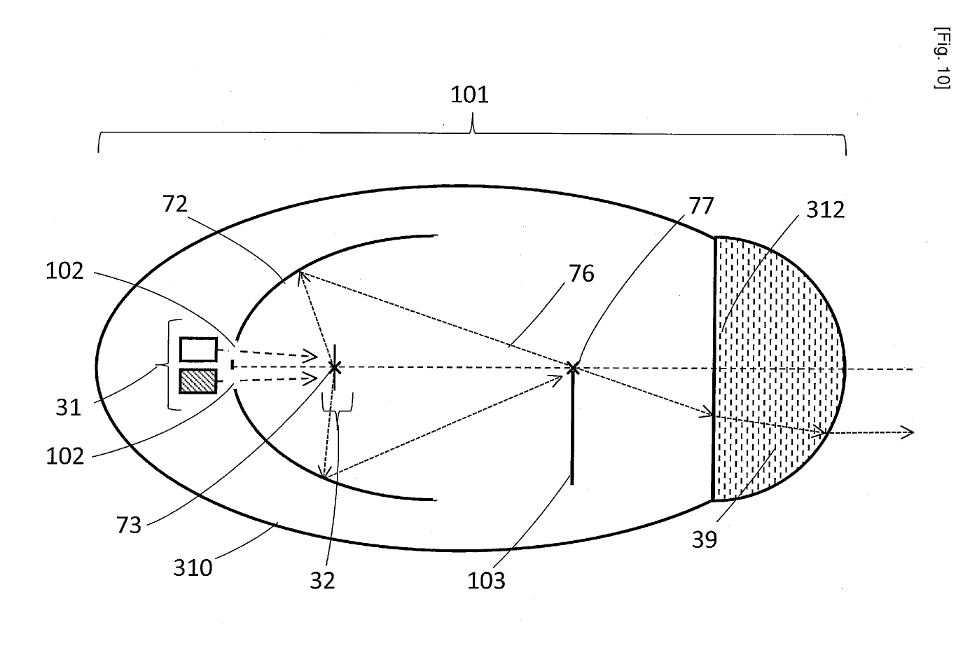

FIG. 9 illustrates a further embodiment of the present invention whereby the light source 32 is rotated about the first focal point 73 such that the optical axis 74 is no longer normal to the surface 75 of the light source 32. By this arrangement the arrangement of laser light emitters 31 and light source 32 can be optimised to suit the particular requirements of the optical system 38 design. The optical system 38 shown is again based upon an elliptical reflector 72, but it can equally constitute any of the configurations disclosed in previous embodiments.

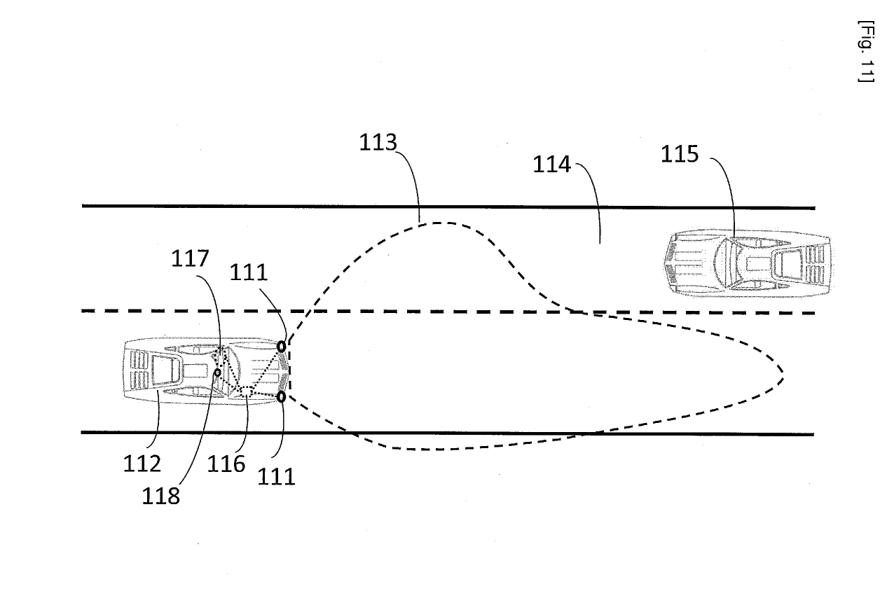

FIG. 10 shows the present invention applied to a projection type automotive headlight 101 which is capable of providing a beam spot on the road which avoids glare to drivers of oncoming vehicles. The light source 32 is located at the first focal point 73 of the elliptical reflector 72. The array of laser emitters 31 is located outside of the elliptical reflector 72 and illuminates the light source 32 through apertures 102 in the elliptical reflector 72. The light 76 emitted from the light source 32 is directed to the second focal point 77 and projected into the far-field by the primary lens 39. The whole projector unit is enclosed in an enclosure 310 which prevents emission of laser light other than through the exit aperture 312 of the enclosure 310. A light shield 103 may be located at the second focal point 77 and blocks part of the projected light beam to generate a beam spot on the road which causes no glare to drivers of other vehicles. This is termed the passing beam. The light shield 103 may also be omitted thereby providing a beam spot on the road termed the driving beam. The light shield 103 may also be controlled such that is can be moved in or out of the path of the light 76, thereby switching between the driving and passing beams. The headlight unit 101 is controlled by input from the driver of the vehicle by turning it on or off, or causing the light shield 103 to be moved in or out of the path of the light 76. This is further illustrated in FIG. 11, which shows a vehicle 112 having front headlights 111. Each of the front headlights 111 may be constituted by a headlight unit of the present invention. For example two headlight units 101 of FIG. 10 may be configured as the aforementioned headlights 111, which constitute the front lighting of the vehicle 112, such that a beam spot 113 is generated on the road 114 which does not cause a glare problem for drivers of other oncoming vehicles 115. The headlights are controlled by a central control unit 116 which receives input from either the driver console 117 or an automated input unit 118, for example a camera, which monitors the conditions of the road 114 and regulates the headlight output accordingly.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

The present invention can alternatively be described as following: this invention addresses both the above-mentioned problems simultaneously by allowing for the simultaneous use of, for example, both UV (herein the term UV will be used to mean both UV and purple wavelengths) and blue laser light sources and a mixture of phosphors to create white light. The phosphor mixture will comprise multiple phosphors, some of which are only excited by light in the UV waveband, herein termed “UV absorbing phosphors”, and phosphors which are only excited by light in the blue waveband, herein termed “blue absorbing phosphors”. In this configuration white light is generated by two methods. Firstly, light in the UV waveband is converted to light of multiple wavebands with longer wavelength by the part of the phosphor mixture comprised only of UV absorbing phosphors. The light in the UV waveband is subsequently blocked to prevent emission from the optical system. Secondly, the part of the phosphor mixture comprised only of blue absorbing phosphors emits light in one or more wavebands with longer wavelength. The light of the blue waveband is not blocked and therefore, exits the optical system. The combination of the light from the UV absorbing phosphors, the light from the blue absorbing phosphors, and the unabsorbed part of the light in the blue waveband are mixed together so that an observer perceives the output as white light. The invention thus provides a white light source with a greatly reduced laser light content (because some of the blue light is generated by conversion of the light in the UV waveband, reducing the intensity needed for the blue laser source) and enhanced safety, whilst also having attributes of the more efficient blue laser based white light source.

The prior art does not suggest the use of both UV (or purple), and blue laser diodes simultaneously.

A laser based light unit may be provided which utilises illumination of a wavelength converting medium, such as a phosphor, by a laser emitter to convert light from the first waveband of a laser emitter to light of a second or more wavebands, with longer wavelength, and by such means provide a white light source. The background art discloses the use of various single waveband laser emitters and various wavelength converting media to produce such white light sources. However, the prior art does not allow for a light source which is comprised of multiple, single waveband laser emitters, each emitting in a different waveband, which are utilised simultaneously with wavelength converting media, which are sensitive only to one of the separate wavebands and not sensitive to both wavebands, such that the combination of almost all emitted and non-converted wavebands forms a white light source, only the light which is non-visible being prevented from exiting the light unit. Therefore, the background art is limited in either terms of efficiency due to the large wavelength shift required to make white light, or in terms of safety, due to the limitations set, by eye safety regulations, upon the power of light that may be emitted by such a system.

a first aspect of the invention is the utilisation of a group of multiple laser emitters which is comprised of emitters in both the UV and blue wavebands. The group of emitters creates an illumination on a light source comprised of a mixture of fluorescent materials sensitive to one or other of the wavebands emitted from the lasers. These fluorescent materials may include phosphors. One set of the phosphors is sensitive to light within the UV waveband but is not sensitive to light within the blue waveband (and may be sensitive only to light within the UV waveband), and upon illumination form such, converts the light to wavebands with longer wavelengths. Two or more phosphors are utilised which emit light in each of two or more wavebands, the resulting combination of light is perceived as white. This white colour is created without any contribution to the final spectrum from the original UV waveband emitted from the laser. The second set of phosphors is sensitive to light within the blue waveband but is not sensitive to light within the UV waveband (and may be sensitive only to light within the blue waveband), and upon illumination from such, converts the light to wavebands with longer wavelengths. One or more phosphors are utilised which emit light in one or more wavebands. The combination of the phosphor emitted light and the non-converted laser emitted light mixes to create a colour perceived as white. Therefore, the final spectrum is inclusive of the original blue laser light. By mixing all of the phosphors together to form one light source and illuminating the entire light source with both sets of lasers, it is possible to generate white light with an efficiency greater than possible with the use of UV lasers alone and a safety which is improved over the use of blue lasers alone. The remaining UV light is removed from the emitted beam, preventing a possible eye safety risk from that waveband. The light source is then combined with an optical system to project the light into the far-field.

The laser based light source is enclosed within an enclosure which prevents the emission of laser light other than through the predefined exit apertures of the enclosure.

The arrangement of the phosphors may be such that the phosphors sensitive to different laser wavelengths are spatially separated upon the surface of the light source. The phosphors may be arranged into a tiled array which alternative between UV absorbing phosphors and blue absorbing phosphors.

The arrangement of the phosphors may be in the form of a non-tiled array.

The arrangement of the phosphors may be in the form of a non-regular array.

The arrangement of the phosphors may be such that the phosphors sensitive to different laser wavelengths are spatially separated upon the surface of the light source in a distribution is defined by the optical system. The white light generated from the UV laser emitters is located closest to the focal point of the optical system and is therefore most collimated. The white light generated from the blue laser emitters is from phosphors located further away from the focal point of the optical system and is therefore less well collimated. This leads to an improved safety of the light source through the more divergent nature of the blue laser light caused by the larger area of the blue emission.

There may be a transition region between the two different sets of phosphors wherein the resulting mixture is neither formed purely from one set of phosphors or the other, but a combination of both.

The substrate upon which the phosphors are deposited may have two tiers. The mixture of phosphor sensitive to UV laser light may be on one tier, which is also closest to the focal point of the optical system. The mixture of phosphors which is sensitive to blue light is on the other tier, which is set back from the focal point of the optical system.

The mixture of all of the phosphors may be changed in composition, such that the phosphors sensitive to UV light may be entirely composed of phosphors which emit in the blue waveband. The resulting emission from these phosphors will generate a blue colour and the residual UV laser light is once again removed. The composition of the mixture of phosphors sensitive to blue laser light is unchanged. The light source is configured such that the blue part of the emitted white light is formed from the emission from the UV sensitive blue phosphor and not the blue laser light. By this method the combination of all the emitted light is still perceived as white and has a similarly reduced blue laser content, thereby improving eye safety further.

The light source may be formed within an optical system based upon an elliptical, hyperbolic, parabolic, spherical or other aspheric shape reflector and a lens.

The light source may be formed within an optical system based upon an elliptical, hyperbolic, parabolic, spherical or other aspheric shape reflector only.

The light source may be rotated with respect to the optical axis of the optical system.

The optical system may comprise a headlight for a vehicle, configured to provide a driving or passing beam spot on the road.

The present invention may also provide a light source system comprising: at least one first light source for emitting light of a first waveband; at least one second light source for emitting light of a second waveband different from the first waveband; a photoluminescent region including a first photoluminescent material and a second photoluminescent material, the first photoluminescent material for, when illuminated by light of the first waveband, absorbing at least some of the light of the first waveband and emitting light in one or more wavebands of longer wavelength than the first waveband and the second photoluminescent material for, when illuminated by light of the second waveband, absorbing at least some of the light of the second waveband and emitting light in one or more wavebands of longer wavelength than the second waveband; wherein, in use, light emitted from the first photoluminescent material, light emitted from the second photoluminescent material, and light of the second waveband that is not absorbed by the second photoluminescent material combine to give a light output having a desired spectral characteristic.

The photoluminescent materials may be fluorescent materials, such as fluorescent phosphors or mixtures of two or more fluorescent phosphors.

For the avoidance of doubt, the term “phosphor” as used herein includes a nanophosphor.

The light source system may further comprise a filter disposed in the path of light from the first photoluminescent material for removing light of the first waveband that is not absorbed by the first photoluminescent material. This is of particular benefit when the first light source(s) is/are laser sources.

The light output may have a white light spectral characteristic.

The first photoluminescent material may emit, when illuminated by light of the first waveband, light in two or more different wavebands of longer wavelength than the first waveband.

Light emitted by the first photoluminescent material in the two or more different wavebands may combine to give light having a white light spectral characteristic. Additionally or alternatively, light emitted by the second photoluminescent material and light of the second waveband that is not absorbed by the second photoluminescent material may combine to give light having a white light spectral characteristic. This may be of particular benefit in embodiments in which the first and second photoluminescent materials are at different positions with respect to a focal point of the optical system, so that at some viewing positions an observer may perceive light pre-dominantly from the first photoluminescent material and at other viewing positions an observer may perceive light predominantly from the second photoluminescent material—if the first photoluminescent material emits white light, and the light from the second photoluminescent material combines with the unabsorbed light of the second waveband also to give white light, an observer will perceive white light at all viewing positions.

The light source system may further comprise an optical system for imaging light emitted by the light source system into the far-field.

The first photoluminescent material may be substantially non-absorbing for light in the second waveband.

The second photoluminescent material may be substantially non-absorbing for light in the first waveband.

The first waveband may be within the wavelength range of from approximately 360 nm to approximately 425 nm, that is to say in the UV and/or purple regions of the spectrum (as noted, this will be referred to as “UV” for simplicity). The first waveband may cover the whole of the wavelength range of from approximately 360 nm to approximately 425 nm, or it may cover only part or parts of the wavelength range of from approximately 360 nm to approximately 425 nm.

The first waveband may be within the wavelength range of from approximately 425 nm to approximately 470 nm, that is to say in the blue region of the spectrum. The first waveband may cover the whole of the wavelength range of from approximately 425 nm to approximately 470 nm, or it may cover only part or parts of the wavelength range of from approximately 425 nm to approximately 470 nm.

The first and second photoluminescent materials may be intermixed with one another.

The photoluminescent region may comprise a region in which the relative proportion of the first photoluminescent material and the second photoluminescent material varies with position across the region. If the first photoluminescent material should generate light having one spectral characteristic, and the second photoluminescent material and the unabsorbed part of the second waveband should generate light having a different spectral characteristic, an observer may perceive different outputs from the system at different viewing positions. Providing such a region of graded composition in the photoluminescent region can prevent a sharp change in the output being perceivable by an observer.

Alternatively the first and second photoluminescent materials may be spatially separated from one another. As an example, the first and second photoluminescent materials may be arranged as one or more regions of first photoluminescent material and as one or more regions of second photoluminescent material (and the region(s) of first photoluminescent material and the region(s) of second photoluminescent material may be disposed on a suitable substrate.

The second photoluminescent material may be disposed further from a focal point of the optical system than the first photoluminescent material (or, for example where the first and second photoluminescent materials are intermixed with one another, the relative proportion of the first photoluminescent material to the second photoluminescent material may vary with distance from the focal point of the optical system).

The second photoluminescent material may be disposed further from a focal point of the optical system than the first photoluminescent material in a direction perpendicular to the optical axis of the optical system or in a direction parallel to the optical axis of the optical system.

The light source system may comprise a substrate, a surface of the substrate may have at least one first portion and at least one second portion non-co-planar with the or each first portion, the first photoluminescent material may be disposed on the one or more first regions of the surface and the second photoluminescent material may be disposed on the one or more second regions of the surface. If the substrate is arranged such that first photoluminescent material is coincident with the focal point of the optical system, the differing thickness of the substrate will mean that the second photoluminescent material is spaced from the focal point. Also, the differing thickness of the substrate will allow good delineation between a region of the first photoluminescent material and a neighbouring region of the second photoluminescent material.

The or each first light source may be a semiconductor laser. The or each second light source may be a semiconductor laser.

A light-incident surface of the photoluminescent region (that is, a surface of the photoluminescent region on which light from the light sources is incident) may be disposed at an angle to the optical axis of the optical system.

A second aspect of the invention provides a headlight for a motor vehicle comprising a light source system of the first aspect.

A third aspect of the invention provides a motor vehicle comprising a headlight of the second aspect.

### INDUSTRIAL APPLICABILITY

The light source disclosed in the present invention may be utilised as a light source for general lighting based upon laser emitters whereby safety and efficiency must be optimised. Furthermore, it may be utilised in automotive lighting whereby the use intense and directional projected light beams may fundamentally limit the light output which may be generated by a blue laser emitter based system only.

### REFERENCE SIGNS LIST

11. light source (prior art 1)

12. light emitting semiconductor element (prior art 1)

13. transparent member (prior art 1)

14. penetrating opening (prior art 1)

21. vehicle headlight (prior art 2)

22. laser irradiation device (prior art 2)

23. fluorescent substance (prior art 2)

24. scattering medium (prior art 2)

25. wavelength selective filter (prior art 2)

26. light not converted by fluorescent substance (prior art 2)

27. cover plate (prior art 2)

31. array of laser emitters

32. light source

33. fluorescent material of the main embodiment

34. substrate

35. UV laser emitter

36. blue laser emitter

37. wavelength selective filter

38. optical system

39. primary lens

310. enclosure

311. face area of substrate

312. exit aperture

313. light of the UV waveband

314. light of the blue waveband

315. multiple waveband emission from the phosphor

316. tiled array

317. non-tiled array

318. non-regular array

41. fluorescent material of the second embodiment

51. focal point

52. UV absorbing phosphor

53. blue absorbing phosphor

54. boundary between different phosphor mixtures

55. boundary region

61. raised central section

62. outer section

63. set back distance

64. discontinuity in the substrate

72. elliptical reflector

73. first focal point

74. optical axis

75. surface of the light source

76. light

77. second focal point

78. reflector vertex

101. projection type automotive headlight

102. aperture

103. light shield

111. headlight

112. vehicle

113. beam spot

114. road

115. oncoming vehicle

116. central control unit

117. driver console

118. automated input unit

1. A light source system comprising:
at least one first light source for emitting light of a first waveband;
at least one second light source for emitting light of a second waveband different from the first waveband;
a photoluminescent region including a first photoluminescent material and a second photoluminescent material, the first photoluminescent material for, when illuminated by light of the first waveband, absorbing at least some of the light of the first waveband and emitting light in one or more wavebands of longer wavelength than the first waveband, and the second photoluminescent material for, when illuminated by light of the second waveband, absorbing at least some of the light of the second waveband and emitting light in one or more wavebands of longer wavelength than the second waveband; and
an optical system for directing light emitted by the light source system into the far-field;
wherein, in use, light emitted from the first photoluminescent material, light emitted from the second photoluminescent material, and light of the second waveband that is not absorbed by the second photoluminescent material combine to give a light output having a desired spectral characteristic;
and wherein the or each first light source and the or each second light source are each a semiconductor laser.

2. A light source system as claimed in claim 1 and further comprising a filter disposed in the path of light from the first photoluminescent material for removing light of the first waveband that is not absorbed by the first photoluminescent material.

3. A light source system as claimed in claim 1 wherein the light output has a white light spectral characteristic.

4. A light source system as claimed in claim 1 wherein the first photoluminescent material emits, when illuminated by light of the first waveband, light in two or more different wavebands of longer wavelength than the first waveband.

5. A light source system as claimed in claim 4 wherein light emitted by the first photoluminescent material in the two or more different wavebands combines to give light having a white light spectral characteristic.

6. A light source system as claimed in claim 1 wherein light emitted by the second photoluminescent material and light of the second waveband that is not absorbed by the second photoluminescent material combine to give light having a white light spectral characteristic.

7. A light source system as claimed in claim 1 wherein the first photoluminescent material is substantially non-absorbing for light in the second waveband.

8. A light source system as claimed in claim 1 wherein the second photoluminescent material is substantially non-absorbing for light in the first waveband.

9. A light source system as claimed in claim 1 wherein the first waveband is within the wavelength range of from 360 nm to 425 nm.

10. A light source system as claimed in claim 1 wherein the first waveband is within the wavelength range of from 425 nm to 470 nm.

11. A light source system as claimed in claim 1 wherein the first and second photoluminescent materials are intermixed with one another.

12. A light source system as claimed in claim 1 wherein the first and second photoluminescent materials are spatially separated from one another.

13. A light source system as claimed in claim 11 wherein the photoluminescent region comprises a region in which the relative proportion of the first photoluminescent material and the second photoluminescent material varies with position across the region.

14. A light source system as claimed in claim 12 wherein the second photoluminescent material is disposed further from a focal point of the optical system than the first photoluminescent material.

15. A light source system as claimed in claim 14 wherein the second photoluminescent material is disposed further from a focal point of the optical system than the first photoluminescent material in a direction perpendicular to the optical axis of the optical system.

16. A light source system as claimed in claim 14 wherein the second photoluminescent material is disposed further from a focal point of the optical system than the first photoluminescent material in a direction parallel to the optical axis of the optical system.

17. A light source system as claimed in claim 14 and comprising a substrate, a surface of the substrate having at least one first portion and at least one second portion non-co-planar with the or each first portion, wherein the first photoluminescent material is disposed on the one or more first regions of the surface and the second photoluminescent material is disposed on the one or more second regions of the surface.

18. A light source system as claimed in claim 1 wherein a light-incident surface of the photoluminescent region is disposed at an angle to the optical axis of the optical system.

19. A headlight for a motor vehicle comprising a light source system as defined in claim 1.

20. A motor vehicle comprising a headlight as defined in claim 19.
